(19) United States
(12) Patent Application Publication
(10) Pub. No.: US 2008/0296136 A1
(43) Pub. Date: Dec. 4, 2008

(54) ROCKER SWITCH COVER ASSEMBLY

(76) Inventors: Francis F. Kelso, Simi Valley, CA (US); James P. Reilly, Camarillo, CA (US)

Correspondence Address: SNELL & WILMER LLP (OC), 600 ANTON BOULEVARD, SUITE 1400, COSTA MESA, CA, 92626, US

(21) Appl. No.: 12/126,782

(22) Filed: May 23, 2008

Related U.S. Application Data
(60) Provisional application No. 60/940,905, filed on May 30, 2007.

(51) Int. Cl. H01H 3/20

(52) U.S. Cl. 200/330

(57) ABSTRACT

A cover assembly for covering at least a part of an electrical switch having a rocker switch actuator, including a face plate defining an opening for permitting at least a part of a rocker switch actuator to extend through the face plate; and a rocker switch member, including a recessed portion, in operative engagement with the face plate. The face plate may have a recessed portion for receiving and operatively engaging a surface of the rocker switch actuator which extends through the face plate. Movement of the rocker switch member from a first position to a second position causes a corresponding movement of the rocker switch actuator when the rocker switch actuator is received and engaged in the recessed portion.

This application claims the benefit and priority of U.S. Provisional Patent Application Ser. No. 60/940,905, filed May 30, 2007, which is herein incorporated by reference for all purposes.

### BACKGROUND

1. Field of the Invention

The present invention relates to the field of switch plates for switches, and more particularly to a wall mountable rocker switch cover that can be fit over installed rocker switches.

2. Related Art

As consumers update and remodel their homes, they are sometimes forced to replace their original switches and face plates, because their original switches and face plates are outdated, soiled or just no longer attractive. However, many homeowners, decorators and do-it-yourselfers do not feel comfortable handling electric wiring and so many hire an electrician to change out the switches. Since many homes have a multitude of such switches, the cost of having an electrician replace them all may be cost prohibitive.

Another problem encountered by persons seeking to modernize or otherwise change the outward appearance of such switches and face plates is that the existing infrastructure of the electrical components is so established that it impedes substantial design changes, without complete replacement of the switch itself. Although the face plate portion may be changed quite readily, it is generally difficult to change the color or shape of the switch actuator, since it is part of the overall switch mechanism that is attached to the electrical wiring. Thus, the installed switch actuator (which remains visible after installation of the face plate) often conflicts with the style, new appearance and/or color of the new face plate. Thus, even if it were possible to obtain a variety of new, clean, colored or modern switch actuators, changing the actuator would involve total replacement of the switch mechanism, which is a time-consuming, skilled and expensive operation.

Therefore, there is a need to find a means of updating old switch actuators in such a way that the switch mechanism would not have to be replaced.

### SUMMARY

The present invention provides the ability to retrofit existing switch actuators with a new appearance while preserving the existing structure of the installed switches that have been installed. More specifically, the present invention provides a face plate assembly that may be used to cover existing rocker switch actuators in a way that makes use of the existing electrical infrastructure of the rocker switch, while hiding the installed rocker switch actuator.

Thus, the desire to have a new appearance or to change the décor of the room can be accommodated in an economical manner, with minimal effort and time, without requiring any rewiring or the use of electricians. The installed rocker switch may continue to function, but with a totally new appearance.

In one aspect of the invention, a cover assembly is provided for covering at least a part of an electrical switch having a rocker switch actuator. The cover assembly includes a face plate defining an opening for permitting at least a part of a rocker switch actuator to extend through the face plate. The cover assembly also includes a rocker switch member, including a recessed portion, in operative engagement with the face plate. The face plate may have a recessed portion for receiving and operatively engaging a surface of the rocker switch actuator which extends through the face plate. Movement of the rocker switch member from a first position to a second position causes a corresponding movement of the rocker switch actuator when the rocker switch actuator is received and engaged in the recessed portion.

In another aspect of the present invention, an electrical switch combination is provided which includes an electrical switch mechanism including a rocker switch actuator and a rocker cover plate assembly. The rocker cover plate assembly includes a face plate, defining an opening for permitting at least a portion of the rocker switch actuator to extend through the face plate, and a rocker switch member. The rocker switch member includes a recessed portion for receiving and operatively engaging a surface of the rocker switch actuator. The rocker switch member is pivotally coupled to the face plate. Movement of the rocker switch member from a first position to a second position causes a corresponding movement of the underlying rocker switch actuator when the rocker switch actuator is received and engaged within the recessed portion.

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

### BRIEF DESCRIPTION OF THE DRAWINGS

The foregoing features and other features of the present invention will now be described with reference to the drawings. In the drawings, the same components have the same reference numerals. The illustrated embodiment is intended to illustrate, but not to limit the invention. The drawings include the following Figures:

FIG. 1 is a perspective elevated view of a rocker cover plate assembly in accordance with an embodiment of the present invention;

FIG. 2 is a perspective rear view of a rocker cover plate assembly in accordance with an embodiment of the present invention;

FIG. 3 is an exploded rear perspective view of the rocker cover plate assembly in accordance with an embodiment of the present invention;

FIG. 4 is a partial exploded view of the front of the rocker cover plate assembly in accordance with an embodiment of the present invention;

FIG. 5 is a partial exploded view of the rear mounting elements of the rocker cover plate assembly in accordance with an embodiment of the present invention;

FIG. 6 is a simplified exploded cross-sectional view of the rocker cover plate assembly and a rocker switch in accordance with an embodiment of the present invention; and

FIGS. 7A and 7B are simplified cross-sectional views of the combined rocker switch actuator and the rocker switch member in accordance with an embodiment of the present invention.

### DETAILED DESCRIPTION

A face plate designed to cover switches and, especially rocker switches, typically has a rectangular opening to allow passage of the switch actuator itself. The portion proximate the rectangular opening covers the remaining, aesthetically undesirable elements of the electrical wiring and rocker switch mechanism. Generally, the switch actuator mechanism has two standard screw holes which align with corresponding holes in the cover plate to allow the cover plate to be attached thereto.

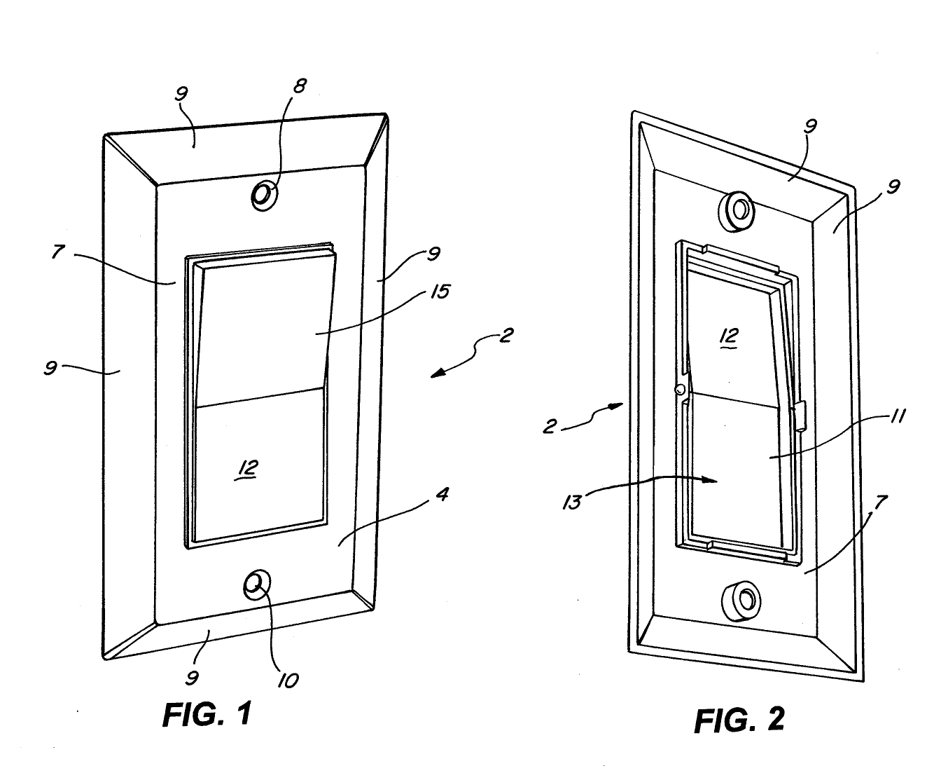

FIGS. 1 and 2 provide perspective front and rear views, respectively, of a rocker cover plate assembly 2 in accordance with an embodiment of the present invention. Rocker cover plate assembly 2 includes a perimeter face plate 4 and a rocker switch member 12, both of which may be molded from an appropriate plastic or similarly appropriate material, for example, a non-conductive material. As described in greater detail below, rocker switch member 12 may be operationally coupled to perimeter face plate 4 such that rocker switch member 12 is allowed to pivot or “rock” about a center point of face plate 4 when an appropriate force is applied thereto.

As shown in FIG. 1, perimeter face plate 4 includes a flat section 7 with truncated perimeter walls 9 which slope away from central flat section 7. As shown in FIG. 2, truncated perimeter walls 9 of perimeter face plate 4 provide an appropriate offset when perimeter face plate 4 is mounted on an installed rocker switch.

Perimeter face plate 4 also includes appropriate mounting holes 8 and 10. In one embodiment, mounting holes 8 and 10 are positioned to match the conventional mounting holes found on the installed rocker switch mechanism so that an appropriate screw can fasten the overlaid rocker cover plate assembly 2 in an operative manner on the installed rocker switch mechanism in accordance with embodiments of the present invention.

In one embodiment, as shown in FIG. 2, rocker switch member 12 defines a recessed portion 11, which is configured to receive an object, such as the rocker switch actuator of the rocker switch mechanism. As described in greater detail below, recessed portion 11 is sized and configured to be overlay the rocker switch actuator such that at least a portion of the surface of rear side 13 of rocker switch member 12 comes into direct or substantially direct contact with a surface of the rocker switch actuator. The direct contact allows the operation of rocker switch member 12 to similarly operate the rocker switch actuator.

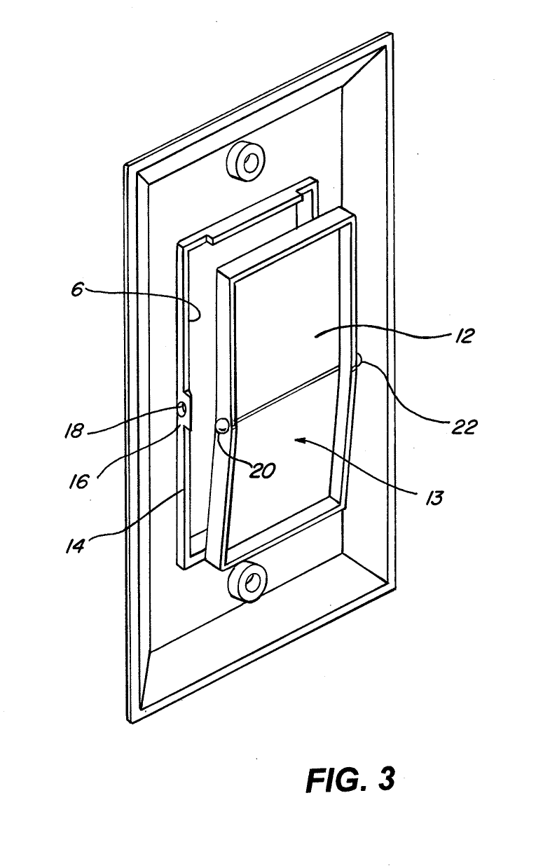

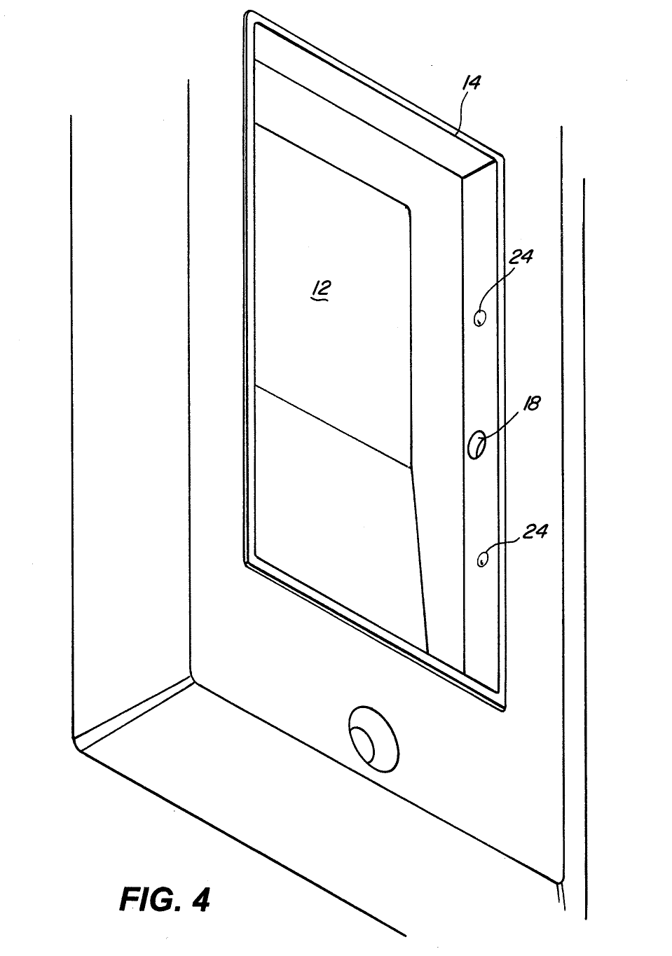

FIG. 3 is an exploded rear perspective view of rocker cover plate assembly 2 in accordance with an embodiment of the present invention. As shown in FIG. 3, perimeter face plate 4 includes an orifice or opening 6 provided to receive the rocker switch actuator there through and sized to allow rocker switch member 12 to also pivot within opening 6.

In one embodiment, to pivotally couple rocker switch member 12 to perimeter face plate 4, a face plate rocker mounting flange 14, including beveled mounting flanges 16, is provided. In one embodiment, mounting flange 14 extends around the perimeter of opening 6 to mate with the perimeter of rocker switch member 12 as well as to add additional strength to opening 6.

In one embodiment, to pivotally mount rocker switch member 12 to mounting flange 14 a pair of centrally located pivot pins 20 and 22 project laterally from the longitudinal sides of rocker switch member 12. These respective pivot pins 20 and 22 may be snap mounted within appropriate mounting holes 18 defined in mounting flange 14. Beveled mounting flanges 16, located on opposing sides of mounting flange 14 and adjacent holes 18, permit the respective pins 20 and 22 to slide along the beveled edge of flange 16 to be slidably received into the respective mounting holes 18 to operatively mount rocker switch member 12 with a minimum of force.

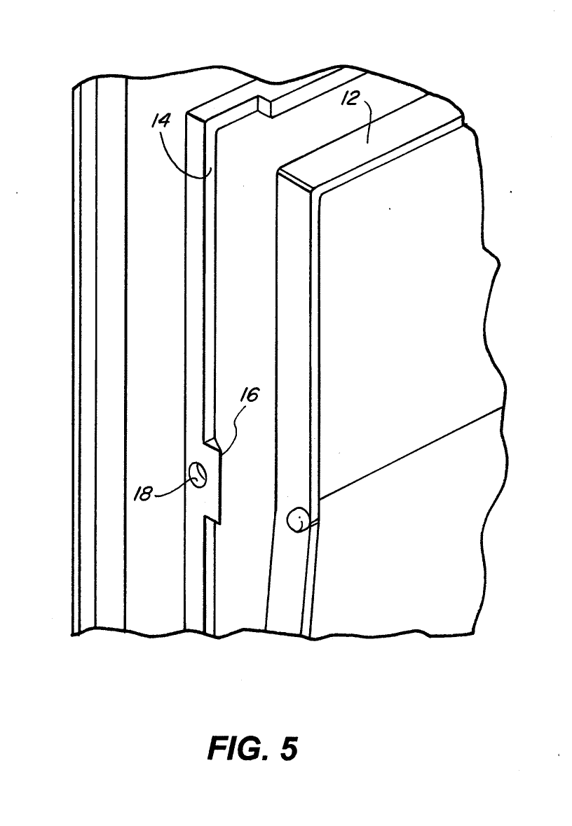

FIGS. 4 and 5 are partial exploded views of the front and rear of rocker cover plate assembly 2, respectively, in accordance with an embodiment of the present invention. As shown in FIG. 4, centering drag buttons 24 may also be provided on mounting flange 14 to center rocker switch member 12 within opening 6. In addition, centering drag buttons 24 may also be used to create drag on rocker switch member 12 so that it does not “flop” and freely rotate when mounted to mounting flange 14. Moreover, centering drag buttons 24 ensure that a prescribed amount of force is needed to overcome the drag force and cause rocker switch member 12 to pivot.

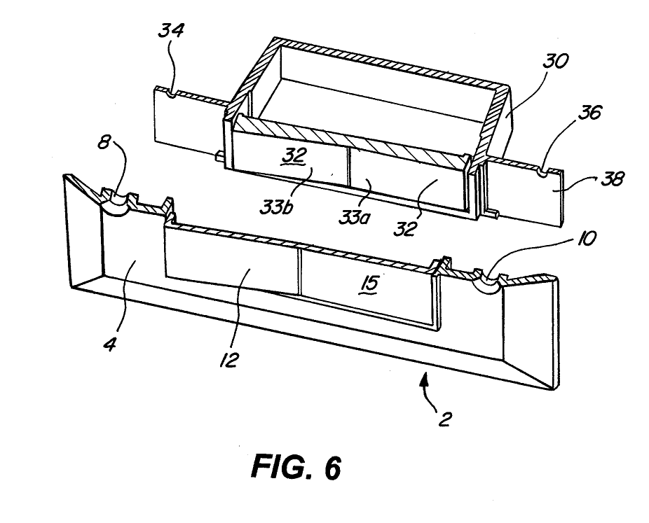

FIG. 6 is a simplified exploded cross-sectional view of rocker cover plate assembly 2 with a conventional rocker switch mechanism 30 combined therewith in accordance with an embodiment of the present invention. In one embodiment, rocker cover plate assembly 2 may be mounted onto rocker switch mechanism 30 by positioning rocker switch member 12 directly over and on top of rocker switch actuator 32 such that a surface 33 of rocker switch actuator 32 is in direct contact, or substantially in direct contact, with the rear side 13 (FIG. 2) of rocker switch member 12. In one embodiment, rocker switch actuator 32 extends through opening 6 of face plate 4 and into recessed portion 11 of rocker switch member 12.

Rocker cover plate assembly 2 may then be affixed to rocker switch mechanism 30 by passing screws through holes 8 and 10 of face plate 4 into corresponding screw holes 34 and 36 in mounting bracket 38.

As best understood with reference to FIG. 6, in operation, when rocker cover plate assembly 2 of the present invention is appropriately mounted and secured to overlay installed rocker switch mechanism 30, rocker switch member 12 is offset adjacent to, and in a substantially parallel manner with, rocker switch actuator 32. Rocker switch member 12 may be placed in direct, or substantially direct, intimate contact with surface 33 of rocker switch actuator 32. The direct and intimate contact between rocker switch actuator 32 and rocker switch member 12 allows a consumer to activate rocker switch actuator 32 by applying an appropriate force to a front side 15 (FIG. 1) of the overlaid rocker switch member 12.

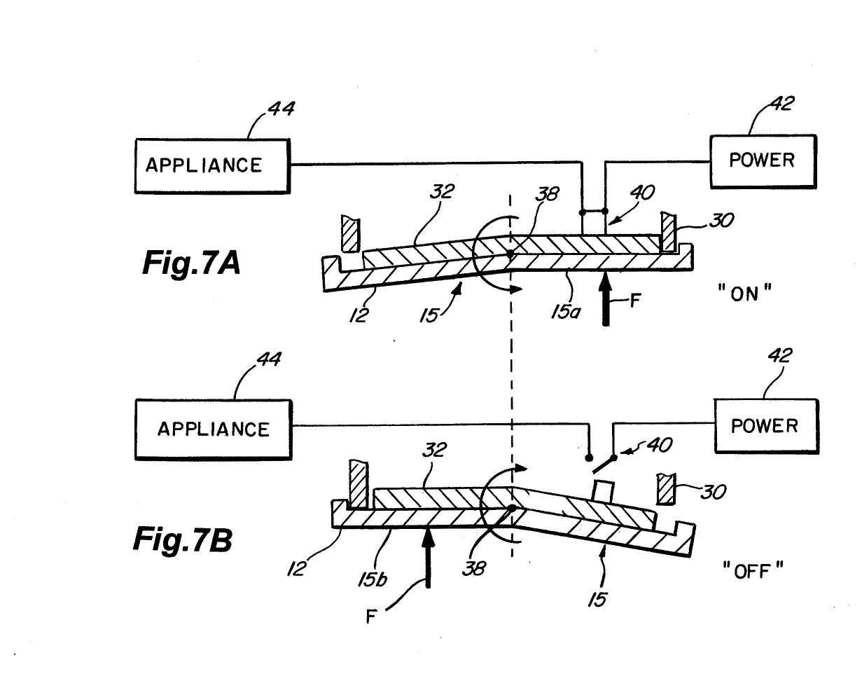

For example, as shown in FIGS. 7A and 7B, rotation R of rocker switch member 12 about a center point 38, such as by application of a force F applied to front side 15, adjacent center point 38, causes the same pivot or rotation R of the underlying installed rocker switch actuator 32.

Specifically, as shown in FIG. 7A, application of force F to a first surface 15a of rocker switch member 12 cause first surface 15a to rotate about center point 38. Since rear side 13 (FIG. 2) of rocker switch member 12 is in contact with surface 33 of rocker switch actuator 32, a first surface 33a on rocker switch actuator 32 correspondingly pivots or rotates R in the same manner causing switch 40 to close thus, creating an electrical connection between power source 42 and a power consuming appliance 44, such as a light, to turn appliance 44 “on.”

As shown in FIG. 7B, application of force F to a second surface 15b of rocker switch member 12 cause first surface 15b to rotate about center point 38. Again, since rear side 13 (FIG. 2) of rocker switch member 12 is in contact with surface 33 of rocker switch actuator 32, a second surface 33b on rocker switch actuator 32 correspondingly pivots or rotates R in the same manner causing switch 40 to open thus, breaking the electrical connection between power source 42 and power consuming appliance 44, to turn appliance 44 “off.”

As consumers update their homes and desire to install more modern looking face plates and rocker switches, the consumers do not have to replace the already installed, original rocker switches. Thus, using cover plate assembly 2 of the present invention, many homeowners and do-it-yourselfers do not have to handle the electric wiring themselves or be forced to hire an electrician.

The present invention allows a user to update old already installed rocker switch actuators so that the installed rocker switch does not have to be replaced. The assembly of the present invention covers the existing interior electrical components in such a way which makes use of the existing electrical infrastructure while hiding the rocker switch actuator which may conflict aesthetically with a cover plate of a different color or design. For example, the present invention allows a consumer to repaint rooms without care of masking the currently installed rocker switches. Any accidental painting of the installed rocker switch actuator is hidden by the rocker switch plate assembly of the present invention when properly installed. In essence, when the consumer repaints a room and gets paint on the installed switch, then the consumer need only cover the switch actuator using the design of the present invention to hide the mistake. As can be appreciated, various design or surface features can be provided for decorative reasons to rocker cover plate assembly 2.

Another advantage of the design of the present invention is that it allows a consumer who wants to change the color or look of an installed rocker switch, to do so without the need for the consumer to hire an electrician to remove the existing rocker switch and install a new switch with the new look that the consumer desires. With the present invention, there is no rewiring involved, thus no electrician is needed to accomplish the consumer's objective.

The present invention has been described above with reference to various exemplary embodiments. However, those skilled in the art will recognize that changes and modifications may be made to the exemplary embodiments without departing from the scope of the present invention.

What is claimed is:

1. A cover assembly for an electrical box including at least one switch having a rocker switch actuator, the cover assembly comprising:
a face plate defining an opening;
a rocker switch member having a front side and a rear side and operatively coupled to said face plate to pivot between a first position and a second position, said rear side of said rocker switch member configured to be mounted directly on a surface of a rocker switch actuator,
wherein movement of said rocker switch member from said first position to said second position causes a corresponding movement of said rocker switch actuator from a first position to a second position.

2. The cover assembly of claim 1, wherein said face plate comprises at least two screw holes positioned to correspond to at least two screw holes in the at least one switch.

3. The cover assembly of claim 1, further comprising a mounting flange disposed along an edge of said opening, said mounting flange comprising a mounting means for said rocker switch member.

4. The cover assembly of claim 3, wherein said mounting means comprises;
pivot pins positioned on longitudinal sides of said rocker switch member; and
corresponding holes defined on said mounting flange, said pivot pins configured to snap into said holes to pivotally secure said rocker switch member to said mounting flange.

5. The cover assembly of claim 4, wherein said mounting means further comprises a beveled mounting flange, wherein said beveled mounting flange allows said pivot pins to be slidably received into said holes.

6. The cover assembly of claim 3, wherein said mounting flange comprises centering drag buttons to center the rocker switch member within the opening.

7. The cover assembly of claim 1, wherein said rear side of said rocker switch member comprises a recessed portion sized configured to overlay the rocker switch actuator, wherein the rear side of rocker switch member is in direct or substantially direct contact with the surface of the rocker switch actuator.

8. The cover assembly of claim 1, wherein said corresponding first position comprises an “off” position and said second position comprises an “on” position of the rocker switch actuator.

9. A cover assembly for covering at least a part of an electrical switch having a rocker switch actuator, said cover assembly comprising:
a face plate defining an opening for permitting at least a part of a rocker switch actuator to extend through said face plate; and
a rocker switch member, including a recessed portion, in operative engagement with said face plate, having a recessed portion for receiving and operatively engaging a surface of said rocker switch actuator which extends through said face plate opening,
wherein movement of said rocker switch member from a first position to a second position causes corresponding movement of said rocker switch actuator when said rocker switch actuator is received and engaged in said recessed portion.

10. The cover assembly of claim 9, wherein said face plate comprises at least two mounting holes positioned to correspond to at least two screw holes in the electrical switch.

11. The cover assembly of claim 9, further comprising a mounting flange disposed along an edge of said opening.

12. The cover assembly of claim 9, further comprising a mounting means for operatively engaging said rocker switch member with said face plate.

13. The cover assembly of claim 12, wherein said mounting means comprises;
a mounting flange defining mounting holes; and
pivot pins positioned on longitudinal sides of said rocker switch member;
said pivot pins configured to snap into said holes to pivotally secure said rocker switch member to said mounting flange.

14. The cover assembly of claim 13, wherein said mounting means further comprises a beveled mounting flange, wherein said beveled mounting flange allows said pivot pins to be slidably received into said mounting holes.

15. The cover assembly of claim 11, wherein said mounting flange comprises centering drag buttons to center rocker switch member within the opening.

16. The cover assembly of claim 9, wherein said rear side of said rocker switch member comprises a recessed portion sized and configured to overlay the rocker switch actuator, wherein the rear side of rocker switch member is in direct or substantially direct contact with a surface of the rocker switch actuator.

17. The cover assembly of claim 9, wherein said corresponding first position comprises an “off” position and said second position comprises an “on” position of the rocker switch actuator.

18. An electrical switch combination comprising:
an electrical switch mechanism including a rocker switch actuator; and
a rocker cover plate assembly, said rocker cover plate assembly including:
a face plate defining an opening for permitting at least a portion of the rocker switch actuator to extend through said face plate; and
a rocker switch member, including a recessed portion pivotally coupled to said face plate, said rocker switch member having a recessed portion for receiving and operatively engaging a surface of said rocker switch actuator,
wherein movement of said rocker switch member from a first position to a second position causes a corresponding movement of said rocker switch actuator when said rocker switch actuator is received and engaged within said recessed portion.

19. The cover assembly of claim 18, wherein said recessed portion is sized and configured to overlay the rocker switch actuator, wherein at least a portion of a rear side of the rocker switch member is in direct or substantially direct contact with a surface of the rocker switch actuator; and wherein movement of said rocker switch member causes a corresponding movement of said rocker switch actuator from a first position or “on” position to a second or “off” position.

20. The cover assembly of claim 18, further comprising a mounting means for pivotally coupling said rocker switch member with said face plate.
